(19) United States
(12) Patent Application Publication
(10) Pub. No.: US 2008/0315133 A1
(43) Pub. Date: Dec. 25, 2008

(54) Uv Irradiation Unit

(76) Inventors: Joachim Jung, Nurtingen (DE); Stefan Jung, Neckarhausen (DE); Melanie Niemann, Ossweil (DE); Carsten Jung, Neckarhausen (DE); Klaus Ebinger, Wernau (DE); Oliver Treichel, Stuttgart (DE); Gunter Fuchs, Unterlenningen (DE); Urs Gumbel, Nurtingen (DE)

Correspondence Address: COLLARD & ROE, P.C., 1077 NORTHERN BOULEVARD, ROSLYN, NY, 11576, US

(21) Appl. No.: 11/664,441

(22) PCT Filed: Sep. 28, 2005
(86) PCT No.: PCT/EP05/10454

§ 371 Date: Aug. 1, 2007

(30) Foreign Application Priority Data
Oct. 1, 2004 (DE) 10 2004 047 868.6

(51) Int. Cl. G01J 3/10

(52) U.S. Cl. 250/504 R

(57) ABSTRACT

The invention relates to a UV irradiation unit comprising a housing (10), a rod-shaped lamp (12) which is arranged therein, a reflector (14) which extends along the UV-lamp (12) and which defines a lamp chamber (22) which surrounds the UV-lamp (12), in addition to a channel system (20) for guiding a cooling coolant through the reflector (14). According to the invention, the channel system (20) is arranged on the outside of the lamp chamber (22) such that it remains void of the coolant flow (24) for operating the lamp in an optimum manner.

The invention relates to an irradiation unit for UV irradiation of substrates, particularly those in web form, having a housing, a rod-shaped UV lamp disposed therein, a reflector that extends along the UV lamp, which delimits the lamp chamber surrounding the UV lamp with regard to a housing interior, and a channel system for passing through a coolant, preferably a gaseous coolant, that cools the reflector.

In the case of units of this type, as they are operated for the polymerization of surface coatings, at high lamp power, lamp and reflector are cooled by means of a gas stream, from the region of the irradiation object all the way to an exhaust air housing. The amount of gas required for cooling is determined by the current/voltage characteristics of the UV lamp and the temperatures of the reflector that are still permissible. It must be avoided, by means of complicated exhaust air regulation mechanisms, that in the case of reduced lamp power or in standby operation, the lamp is cooled too greatly and, when this happens, the gas discharge breaks off, because otherwise, the lamp must be cooled down for re-ignition, which is time-consuming. In operation, ozone is primarily generated in the lamp chamber, by means of the short-wave UV light. This process takes place continuously, since cooling air that contains ozone is constantly drawn off for cooling of the unit. As a result, however, part of the energy-rich UV light is no longer available at the object surface for the polymerization process. Furthermore, fission products from the object region can deposit on the reflector by means of the cooling gas stream, and the exhaust air is contaminated with fission products and ozone.

Proceeding from this, the invention is based on the task of avoiding the disadvantages that occur in the state of the art, and of improving a unit of the type indicated initially, to the effect that irradiation optimization is achieved with simple means.

To accomplish this task, the combination of characteristics indicated in claim 1 is proposed. Advantageous embodiments and further developments of the invention are evident from the dependent claims.

Accordingly, it is proposed, according to the invention, that the channel system for the coolant guidance is disposed outside of the lamp chamber, so that the lamp chamber remains free of the cooling gas flow, whereby the reflector is formed as part of the channel system, by means of hollow profiles to which cooling gas can be applied on the inside. Since therefore the lamp chamber surrounded by reflector and object does not have oxygen continuously applied to it, an ongoing optical absorption process by means of ozone formation towards the outside can be prevented. In this way, either the production output can be significantly increased, or alternatively, the same drying results are achieved with a lower specific power, as in the case of units with lamp chamber cooling. Furthermore, clean separation of the device functionalities is possible, whereby it is possible to do without regulation of the air cooling in the case of different power states of the lamp. A particularly simple structure with low space requirement and effective cooling is possible with the hollow profiles, which are preferably extruded.

It is advantageous if the reflector can preferably allow flow over its entire length, crosswise to the longitudinal direction of the UV lamp, so that temperature gradients in the longitudinal direction of the lamp are also avoided, to a great extent.

Another advantageous embodiment provides that the channel system has an inflow chamber delimited by a double-walled housing mantle. In order to create uniform cooling conditions over the lamp length, it is also advantageous if the channel system has an exhaust air chamber that extends parallel to the UV lamp, preferably disposed after an absorber, and if the flow cross-section of the exhaust air chamber is preferably greater, by a multiple, than the greatest flow cross-section of the channel system in the inflow side.

In a structurally advantageous embodiment, a housing insert part is disposed in the housing as part of the channel system.

In order to minimize the production and operating effort, the channel system is exclusively configured for passing through a gaseous coolant.

Another improvement is achieved in that an absorber to which radiation is applied by the lamp, at least in standby operation, is disposed in the housing interior, and that the absorber can be cooled by means of the cooling gas flow. In this connection, it is advantageous if the absorber delimits a region of the channel system, preferably in the form of a labyrinth that deflects the cooling gas flow.

According to another preferred embodiment of the invention, the reflector possesses two reflector halves that can be pivoted, relative to one another, between an operating position directed at the substrate, and a standby position directed at an absorber in the housing interior, whereby the reflector halves stand in engagement with the absorber in the standby position, leaving the lamp chamber free of the cooling gas flow.

It is advantageous if the ratio of ongoing operation power to the length of the UV lamp is greater than 20 W/cm, preferably greater than 100 W/cm. In this connection, as well, it is possible that the cooling gas flow is predetermined independent of the lamp power in irradiation operation.

By means of shielding the lamp chamber with regard to passing ozone out (whereby the reflector and, if necessary, the substrate, form barriers), it is possible to keep the lamp chamber under ozone saturation during irradiation operation, so that only a little UV radiation is lost for ozone formation.

Another improvement provides that the lamp chamber is separated from the substrate by means of a separating disk that is permeable for radiation, particularly a quartz disk. In order to keep it clear of deposits, it is possible to heat the separating disk a temperature of more than 300° C. during irradiation operation, by means of the UV lamp.

In order to allow the most homogeneous gas stream possible, it is advantageous if the reflector can have cooling gas applied to it by way of longitudinal-side openings, on a longitudinal side that runs on the longitudinal lamp direction.

A flow line and, if necessary, a valve function in the case of a folding reflector, can advantageously be achieved in that the reflector can be brought into engagement with housing seals on a longitudinal side that runs in the longitudinal lamp direction, in order to pass cooling gas through.

In the following, the invention will be explained in greater detail using an exemplary embodiment shown schematically in the drawing. This shows:

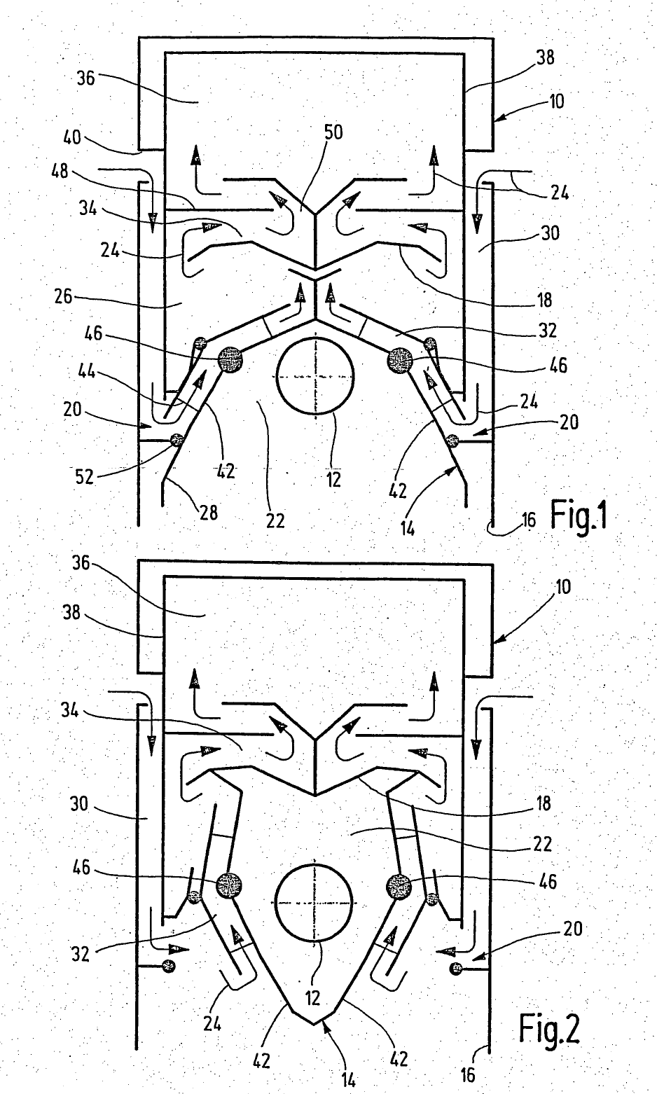

FIG. 1 a UV irradiation unit in the operating state, in simplified manner, in cross-section; and

FIG. 2 the irradiation unit according to FIG. 1 in the standby state.

The UV irradiation unit shown in the drawing serves for UV drying and cross-linking of varnishes, paints, adhesives, and coatings of the same type, particularly on substrates or products in web form. It consists essentially of a box-shaped housing 10, a rod-shaped UV lamp 12 disposed therein, a reflector 14 for reflection of the emitted UV light onto an irradiation opening 16 on the bottom, a radiation absorber 18 inside the housing, for standby operation, and a channel system 20 for passing through cooling air.

The UV lamp 12, as a medium-pressure gas discharge lamp having two ends, is disposed in the center longitudinal plane of the housing 10, and gives off its radiation by way of the housing opening 16, onto the substrate web passed by underneath the latter, i.e. onto the object to be irradiated. The channel system 20 of the cooling system is disposed completely outside of the lamp chamber 22 that surrounds the lamp 12, so that this chamber remains free of the cooling air flow (arrows 24).

As shown in FIG. 1, the UV lamp 12 is surrounded by the reflector 14 in the operating state, by way of its sector that faces away from the housing opening 16, so that the reflected light is emitted through the housing opening 16, and the adjacent housing interior 26 is shielded with regard to the lamp chamber 22. In this connection, the waste heat that occurs can be absorbed by way of the cooling air flow 24 that is passed along the back of the reflector surface 28, and passed out of the housing 10.

For this purpose, the channel system 20, which is symmetrical with regard to the longitudinal center plane of the housing 10, comprises an inflow channel 30, a reflector channel 32, an absorber channel 34, and an exhaust air chamber 36. The air flow in the channels 30, 32, 34 takes place over the length of the housing 10, crosswise to the longitudinal axis, while the exhaust air flow in the exhaust air chamber 36 takes place mainly in the longitudinal direction, towards a draw-out opening, not shown.

For delimiting the various flow regions, a housing insert 38 is disposed in the housing 10, which extends continuously, lengthwise, between the housing face sides. In this manner, a double-walled housing mantle is formed as an inflow channel 30, downstream from an inflow slit 40. The subsequent reflector channel 32 consists of profile cavities, which are formed in the reflector 14 that is composed of extruded profile pieces 42. The profile pieces 42 possess a double wall with intermediate crosspieces 44 that is perforated for forming longitudinal-side passages, and can be pivoted relative to one another about an axle of rotation 46, in each instance. The rotation function for standby operation will be explained below.

The cooling gas that exits from the reflector 14 is deflected by the absorber 18, also configured as a profile section, whereby guide plates 48 that project inward form a flow labyrinth 50 on the housing insert 38. Because of the very much greater volume, i.e. flow cross-section of the exhaust air chamber 36, it is guaranteed that uniform air speeds and therefore cooling conditions exist over the entire housing length.

In the operating position according to FIG. 1, the reflector 14 is directed towards the object to be irradiated, while heat-resistant housing seals 52 assure direct introduction of cooling air. During startup or in the case of interruptions in operation, the unit is brought into standby operation, during which the reflector 14 is closed towards the housing opening 16, and open towards the absorber 18 in the housing interior.

The standby position can be assumed, according to FIG. 2, in that the reflector halves 42 are pivoted about the axles of rotation 46, until the lower reflector edges close against one another and the upper reflector edges come into engagement with the absorber 18. In this operating state, as well, the lamp chamber 22 remains free of the cooling air flow 24, while the reflector 14 and absorber 18 continue to be cooled under deflection of the flow. In this way, it is possible to keep the lamp 12 burning even in standby operation, whereby the absorber 18 absorbs the (reduced) radiation. It is possible to switch from this operating state into the production mode that corresponds to the pre-setting, in each instance, without any time loss, by opening the reflector 14.

In this connection, it is of particular significance that the short-wave UV-C radiation in the range of 200 to 240 nm wavelength generates ozone in the lamp chamber, if oxygen is present. Because of the separated cooling air flow, however, it is possible to work in ozone saturation, without continuous ozone formation, so that the short-wave radiation yield for the polymerization process at the substrate surface is significantly improved. By means of the more rapid hardening of a thin surface layer, the oxygen influence (inhibition) on the polymerization in the depth of the coating can also be reduced.

In experiments with the device according to the invention, it was shown that UV lamps having a specific power of 200 W/cm up to a lamp length of approximately 50 cm can be operated up to several 1000 hours without air flow in the lamp chamber. This holds true for reflectors having an aluminum coating, just as well as for reflectors having a dichroitic coating on solid carriers (so-called cold light mirrors). In this connection, cooling can be implemented by means of pure air cooling. If such units are used, the same drying results are obtained with a lower specific lamp power as in the case of devices with lamp chamber cooling, or alternatively, the production output can be dramatically increased.

By means of the separation of lamp chamber 22 and channel system 20, it is also possible to do without regulation of the coolant flow in the case of different operating/power states of lamp and reflector.

Fundamentally, it is possible to separate the lamp chamber from the substrate by means of a UV-permeable quartz disk (not shown). In this connection, the quartz disk can be heated to temperatures above 300° C. by means of the emission of the UV lamp, so that no deposits form on the object side of the disk. In order to create a further oxygen-reduced atmosphere in the exposure chamber, it is advantageous if nitrogen gas is injected at the intake of the material web, preferably by means of a laminar nozzle, at a gas speed that is less than the web speed.

1. Irradiation unit for UV irradiation of substrates, particularly those in web form, having a housing (10), a rod-shaped UV lamp (12) disposed therein, a reflector (14) that extends along the UV lamp (12), which delimits the lamp chamber (22) surrounding the UV lamp (12) with regard to a housing interior (26), and a channel system (20) for passing through a coolant that cools the reflector (14), whereby the reflector (14) forms part of the channel system (20) disposed outside of the lamp chamber (22), wherein the reflector (14) is formed by hollow profiles (42) to which cooling gas can be applied on the inside, to allow flow through crosswise to the longitudinal direction of the UV lamp (12), and that the lamp chamber (22) remains free of the cooling gas flow (24).

2. Irradiation unit according to claim 1, wherein the reflector (14) can preferably allow flow over its entire length, crosswise to the longitudinal direction of the UV lamp (12).

3. Irradiation unit according to claim 1, wherein the reflector (14) is formed by extruded hollow profiles (42) that run in the longitudinal direction of the UV lamp (12).

4. Irradiation unit according to claim 1, wherein the channel system (20) has an inflow chamber (30) delimited by a double-walled housing mantle.

5. Irradiation unit according to claim 1, wherein the channel system (20) has an exhaust air chamber (36) that extends parallel to the UV lamp (12), preferably disposed after an absorber (18).

6. Irradiation unit according to claim 1, wherein the flow cross-section of the exhaust air chamber (36) is preferably greater, by a multiple, than the greatest flow cross-section of the channel system (30, 32, 34) on the inflow side.

7. Irradiation unit according to claim 1, wherein a housing insert (38) is disposed in the housing (10) as part of the channel system (20).

8. Irradiation unit according to claim 1, wherein the reflector (14) is cooled exclusively by means of cooling gas and not by means of liquid cooling medium.

9. Irradiation unit according to claim 1, wherein an absorber (18) to which radiation is applied by the UV lamp (12), at least in standby operation, is disposed in the housing interior (26), and that the absorber (18) can be cooled by means of the cooling gas flow (24).

10. Irradiation unit according to claim 9, wherein the absorber (18) delimits a region of the channel system (20), preferably in the form of a labyrinth (50) that deflects the cooling gas flow (24).

11. Irradiation unit according to claim 1, wherein the reflector (14) possesses two reflector halves (42) that can be pivoted, relative to one another, between an operating position directed at the substrate, and a standby position directed at an absorber (18) in the housing interior (26), whereby the reflector halves (42) stand in engagement with the absorber (18) in the standby position, leaving the lamp chamber (22) free of the cooling gas flow (24).

12. Irradiation unit according to claim 1, wherein the ratio of ongoing operation power to the length of the UV lamp (12) is greater than 20 W/cm, preferably greater than 100 W/cm.

13. Irradiation unit according to claim 1, wherein the cooling gas flow (24) is predetermined independent of the lamp power in irradiation operation.

14. Irradiation unit according to claim 1, wherein the lamp chamber (22) is shielded with regard to passing ozone out, whereby the lamp chamber (22) stands under ozone saturation during irradiation operation.

15. Irradiation unit according to claim 1, wherein the lamp chamber (22) is separated from the substrate by means of a separating disk that is permeable for radiation, particularly a quartz disk.

16. Irradiation unit according to claim 1, wherein the separating disk is heated to a temperature of more than 300° C. during irradiation operation, by means of the UV lamp (12).

17. Irradiation unit according to claim 1, wherein the reflector (14) can have cooling gas applied to it by way of longitudinal-side openings, on a longitudinal side that runs in the longitudinal lamp direction.

18. Irradiation unit according to claim 1, wherein the reflector (14) can be brought into engagement with housing seals (52) on a longitudinal side that runs in the longitudinal lamp direction, in order to pass cooling gas through.
